(19) United States
(12) Patent Application Publication
(10) Pub. No.: US 2012/0163782 A1
(43) Pub. Date: Jun. 28, 2012

(54) Backdrop Support

(76) Inventor: Alexander Brendan McColl, Edinburgh (GB)

(21) Appl. No.: 13/332,716

(22) Filed: Dec. 21, 2011

(30) Foreign Application Priority Data
Dec. 24, 2010 (GB) 1022008.5

(51) Int. Cl. G03B 15/00

(52) U.S. Cl. 396/3

(57) ABSTRACT

A backdrop support is presented comprising a stand and a flexible support sheet. The stand comprises a base end having a surface engaging formation for standing on a surface, and an opposed support end. The flexible support sheet is attached or attachable to at least the support end of the stand such that the flexible support sheet can extend from the stand and form a curved surface; wherein the backdrop support further comprises at least one sheet retaining formation configured to retain one or more sheets on the flexible support sheet.

The presented backdrop support allows the colour of the backdrop of a photograph to be readily changed by simply replacing a coloured sheet retained by the at least one sheet retaining formation with a different coloured sheet without disassembling the backdrop support of changing the lighting.

### FIELD OF THE INVENTION

The invention relates to the field of photography and in particular to a support for a backdrop for photographs, including still photographs and images for stop-motion video.

### BACKGROUND TO THE INVENTION

It is often desirable to be able to photograph an object such as a product or engineering part, for example, with a plain, featureless background so that there is nothing in the shot to detract from the object, or to enable the resulting image of the object to be readily included in a publication, such as a catalogue. In these instances a photograph is often taken against a white backdrop. However, the angle of the camera shot must be chosen carefully to ensure that the horizon of the shot (that is, where the surface on which the object is placed meets the white backdrop) is not captured in the photograph.

One solution to this problem is to form a curved backdrop, such that the surface on which the object sits curves smoothly upwards from the horizontal to form the backdrop. For example, a curved white sheet may be used, extending beyond the surface on which the object is sat in use and attached to the wall behind the object. In professional studios, a white sheet may be draped from a wall onto the floor and the object placed on the floor.

For relatively small objects, (for example a boot or bottle) backdrops can be purchased which incorporate a background curving down to a surface upon which an object may be placed. An example of this type of backdrop is the Manfrotto 320 Mini Still Life Table (available from Manfrotto Supports by Lino Manfrotto+Co., S.p.A. of Bassano del Grappa, Italy). A white backdrop is provided with a solid metal frame for support. Such a product is suitable for shooting photographs of objects within a professional studio. However, if photographs need to be taken outside of the studio, this device is too heavy and cumbersome to be conveniently moved to alternative locations for the photographs to be taken.

Another example of a suitable backdrop is the Novoflex MagicStudio (available from NOVOFLEX Präzisionstechnik GmbH of Memmingen, Germany, U.S. Pat. No. 7,054,549). A white backdrop with a series of holes along the sides is provided with a pair of beaded cords, each of which may be attached to holes at opposite ends of the backdrop to produce a curved backdrop, equivalent to the string of a bow. However, the beaded cords can cast a shadow on the object to be photographed, limiting the range of angles from which photographs can be taken and constraining the possible ways in which the object may be lit.

It is an object of an aspect of the invention to provide apparatus for forming a backdrop suitable for object photography, which is portable and does not limit how an object may be lit.

It may also be desirable for an object to be photographed against a coloured backdrop, where the backdrop smoothly changes colour (a colour gradient), from the top of the backdrop to the bottom, for example. Traditionally, such an effect is achieved by providing a coloured backdrop as described above and then carefully lighting the backdrop from the front through one or more coloured gels. Such a set up is intricate and time and space consuming, and also requires that the light from the coloured gels colours the backdrop but does not colour the object itself.

It is a further object of some embodiments of the invention to enable a user to produce a colour gradient backdrop, simply and quickly. Some embodiments of the invention aim to provide a readily portable apparatus backdrop which requires only a limited volume of space.

### SUMMARY OF THE INVENTION

According to a first aspect of the invention there is provided a backdrop support comprising a stand and a flexible support sheet; the stand comprising a base end having a surface engaging formation for standing on a surface, and an opposed support end; the flexible support sheet being attached or attachable to at least the support end of the stand such that the flexible support sheet can extend from the stand to form a curved surface; wherein the backdrop support further comprises at least one sheet retaining formation configured to retain one or more sheets on the flexible support sheet.

Thus, one or more flexible sheets may be mounted on the flexible support sheet to form a backdrop.

The flexible support sheet may be attached to at least the support end of the stand. The flexible support sheet may be attachable (typically, demountably attachable) to at least the support end of the stand. The flexible support sheet may also be attached or attachable to at least one other part of the stand.

The flexible support sheet may comprise a first edge and an opposed second edge. The flexible support sheet may be attached to at least the support end of the stand at the first edge of the flexible support sheet and the opposed second edge may be the edge of the flexible support sheet furthest from the stand in use. However, in some embodiments the flexible support sheet extends past (i.e. upwards in use, away from the surface on which the backdrop support is placed) where it is attached or attachable to the stand.

Preferably, the flexible support sheet, when attached to the support end of the stand, forms a curved surface with an incurvate upper surface and an excurvate lower surface (in use). Thus, the invention extends to the backdrop support with the flexible support sheet attached to at least the support end of the stand and curved with an incurvate upper surface and an excurvate lower surface. In some embodiments, the flexible support sheet is attached or attachable to the stand at at least two locations along the length of the flexible support sheet to define the curvature of the flexible support sheet at least in part. Preferably, the at least one sheet retaining formation is configured to retain one or more sheets on the flexible support sheet on the incurvate upper surface.

Preferably, the flexible support sheet comprises at least one said sheet retaining formation. The stand may comprise at least one said sheet retaining formation. It may be that the flexible support sheet comprises at least one said sheet retaining formation and the stand comprises at least one said sheet retaining formation.

At least one said sheet retaining formation may comprise a tab defined by a cut in the flexible support sheet.

Backdrops known in the art are generally a single sheet (a white translucent or opaque sheet) fixed to a frame and curved to form the backdrop. To change the colour of the backdrop, it is necessary to either disassemble the sheet from the frame and then mount a different sheet to the frame, or to light the existing backdrop with coloured light carefully directed to avoid lighting the object to be photographed with the coloured light. The provision of at least one sheet retaining member allows sheets of different colours to be interchanged between photographs quickly and easily, without the need to disassemble the backdrop or change the lighting. Therefore, photographs with different coloured backgrounds can be produced for an object much faster than by using known backdrops, thereby reducing the associated costs.

The flexible support sheet may comprise at least two sheet retaining formations. For example, a sheet retaining formation may be adjacent to each of the first and second edges of the flexible support sheet such that a sheet may be held in place on the flexible support sheet between the two sheet retaining formations. Nevertheless, a simple sheet retaining formation, for example located at the base of the flexible support sheet (the end opposite where the flexible support sheet is attached to or attaches to the stand) may be employed. The stand may comprise side walls which extend beyond (above in use) the adjacent flexible support sheet to guide sheets retained on the flexible support sheet.

Preferably, in use the backdrop support stands on a horizontal surface, such as a table or floor so that the surface engaging formation of the base end of the stand abuts the horizontal surface with the support end of the stand above it. The flexible support sheet may be supported by the support end of the stand such that the flexible support sheet forms a curved surface and extends from the stand to a plane generally parallel with the surface on which the backdrop support is standing. The flexible support sheet may rest on the surface on which the stand is resting. Alternatively, the flexible support sheet may be supported by the base end of the stand and by the support end of the stand. In this case, the base end may extend forward of the support end of the stand in use to support the flexible support sheet forward of the location where the flexible support sheet attached to the support end of the stand.

Preferably, the backdrop support is substantially transparent. The stand of the backdrop support may be substantially transparent. The flexible support sheet of the backdrop support may be substantially transparent. Preferably, the stand and the flexible support sheet are substantially transparent. By substantially transparent we mean colourless and sufficiently clear to allow the substantial majority (at least 75%) of light to pass through. Preferably, the flexible support sheet or the stand, and typically the backdrop support (comprising both the flexible support sheet and the stand), allow at least 85% of light to pass through. For example, the backdrop support may be formed from colourless material (e.g. polypropylene) allowing around 90% or around 95% of light through.

Backdrops known in the art are generally bulky apparatus with large frames to provide strength and support to the backdrop. However, bulky frames may cast shadows onto the object to be photographed if the lighting is provided from specific directions. Therefore, the lighting options available to the photographer are restricted. The provision of a backdrop support where the backdrop support is substantially transparent allows the photographer to direct the lighting however he wishes, as the substantially transparent backdrop support will not cast a shadow onto the object to be photographed. In addition, the provision of a transparent backdrop support which may retain coloured flexible sheets (translucent or opaque) allows the user to choose the colour of backdrop by selecting a suitably coloured flexible sheet to be retained by the backdrop support, and allows more complex effects to be achieved, detailed below.

The provision of a substantially transparent stand is of particular use if it is desirable to illuminate the object from either behind or below the stand. Such an effect may be desirable where the sheet forming the backdrop is translucent, for example. Conventional backdrops with large frames may cast shadows on the product where a substantially transparent stand would not.

Preferably, the stand of the backdrop support is made of a flexible substantially transparent plastic material, such as polypropylene, polyethylene or acetate, for example. Alternatively the stand of the backdrop support may be made of a rigid transparent material such as a rigid transparent plastics material (such as, polypropylene, polystyrene or polycarbonate) or a glass, for example.

Preferably, the flexible support sheet curves smoothly in use, without creases or wrinkles. This provides a substantial benefit over backdrops formed using fabrics which can crease.

Preferably, the flexible support sheet of the backdrop support is made of a flexible substantially transparent plastics material, such as polypropylene polyethylene or acetate, for example.

Alternatively, the backdrop support may be coloured. The coloured backdrop support may be opaque. The coloured backdrop support may be translucent. The coloured backdrop support may be formed from a translucent plastics material. For example, the backdrop support may be coloured green and used as a backdrop for green screen imaging, where the green backdrop is replaced with another image using image processing.

Preferably, the backdrop support is collapsible. The flexible support sheet may be demountably attached to the support end of the stand.

Backdrop supports known in the art generally have large cumbersome frames to provide a solid structure around the backdrop sheet. Such structures are adequate in a professional studio but are not viable if the backdrop support is required to be moved to a client's premises, for example.

Preferably, the backdrop support may be collapsed or collapsible into one or more flat components. For example, the stand may be collapsible into one or more flat components and the flexible support sheet may be collapsible into a flat component or may be a flat component. In embodiments, the components may be stored in a folder or substantially flat carry case that may be readily carried by hand. Accordingly, the backdrop support may be easily and conveniently transported from a studio to whichever location it is required to go to.

The invention extends to the backdrop support in a collapsed state. In its collapsed state, the backdrop support may be in the form of a stack of sheets including the one or more flexible sheets. In its collapsed state, the backdrop support may be a single sheet comprising a sheet portion forming the stand and a sheet portion forming the flexible support sheet. In its collapsed state, the backdrop support may comprise a sheet forming the stand and a separate sheet forming the flexible support sheet.

The flexible support sheet length (i.e. the dimension extending from the lowest point of the flexible support sheet to the highest point in use) may be at least 1.5 times the distance from the base end to the support end of the stand, preferably, the flexible support sheet length may be at least 1.7 times the distance from the base end to the support end of the stand. The length of the flexible support sheet may be at least 2.0 times the distance from the base end to the support end of the stand. Sheets provided to be retained on the flexible support sheet typically have the same dimensions as the flexible support sheet.

The length of the flexible support sheet is preferably sufficient that it forms a flat lower region in use. An item to be photographed can then be placed on the flat region.

The invention extends to a backdrop comprising the backdrop support and one or more flexible sheets retained on the flexible support sheet.

Preferably, at least one of the one or more sheets are coloured or white. At least one of the one or more sheets may be translucent. The one or more sheets may comprise an opaque sheet. The backdrop support may be placed upon one of the sheets, such as an opaque or translucent white sheet to improve the uniformity of light incident on the flexible support sheet.

The depth of colour observed by a camera or eye may be dependant on the thickness of retained translucent flexible coloured sheets the transmitted light has passed through. For example, light observed from the top of the backdrop support, where a translucent flexible coloured sheet is approximately normal to the observer, may be appear to be of a lighter colour than that observed from the bottom of the backdrop support, where the translucent flexible coloured sheet is at a shallower angle with respect to the observer and therefore the light has travelled through more of the translucent flexible coloured sheet.

A brightly coloured opaque or translucent sheet may be retained on the flexible support sheet and used as a backdrop, where the brightly coloured backdrop is replaced with another image using image processing. For example, the brightly coloured sheet may be green.

The provision of a backdrop support that may retain interchangeable opaque or translucent coloured or white sheets, allows the colour of the background used to form the backdrop of the photographed object to be changed easily and quickly, without having to disassemble the backdrop support or to use coloured lights.

Therefore, the provision of a backdrop support that can readily demountably retain different combinations of sheets of different colours allows an object to be photographed with different coloured backdrops whilst being illuminated with the same white light as the backdrop and with the same lighting arrangement, thus simplifying the changes that need to be made between different photographs and thereby reducing the preparation time required to take photographs of an object in front of a variety of coloured backdrops.

The flexible support sheet may retain a translucent flexible coloured or white sheet and be spot lit from behind. That is the centre of the backdrop support may be brightly lit, and the edges of the backdrop support may be dimly lit. Such a lighting arrangement may produce a haloing effect around an object to be photographed placed on the translucent flexible coloured or white sheet.

Preferably, the or each said sheet retaining formation is configured to retain two or more sheets at once. For example, the or each sheet retaining formation may retain two sheets. The two sheets retained by the at least one sheet retaining formation may be translucent. Preferably, the at least two sheets are translucent and of different colours such that when curved and illuminated a colour gradient is produced.

In many instances it is desirable to photograph an object such as a product or machine part against a plain, monotone backdrop. However, it is often more effective to photograph such an object against a duotone backdrop or colour gradient, where a first colour smoothly changes to a second colour from the top to the bottom of the backdrop such as purple to red, for example. Traditionally, one way to achieve this effect would be to set up a red backdrop and then light a part of the top of the backdrop with blue light. However, great care must be taken when positioning the blue light to ensure that the object to be photographed is not lit by the blue light.

The provision of a backdrop support configured to retain at least two sheets allows a colour gradient to be achieved without the use of coloured lighting. In embodiments with two translucent coloured sheets of different colours retained that are lit from behind, (that is, the translucent coloured sheets are between the object and the light source) light received by a camera or the eye of an observer from the top of the backdrop is mostly transmitted through the two curved sheets and thereby the colour of the backdrop will be a combinations of the colours of the two curved sheets. For example, a blue sheet on a red sheet would create a purple backdrop. However, the thickness of each sheet through which light passes will vary along the length of the flexible support sheet. Thus, light from towards the bottom of the backdrop where the flexible support sheet curves until it is parallel with the horizontal surface on which the backdrop support is rested, will be coloured predominantly by the uppermost sheet whereas light from towards the top of the backdrop will be coloured evenly by each colour translucent sheet on the backdrop, when lit from behind. Therefore, the colours of the top and bottom of the backdrop will appear to be different to a camera or to an observer, providing a smooth colour gradient. Furthermore, another contribution to a smooth colour gradient from the top of the backdrop to the bottom can arise because the backdrop smoothly curves from the top to the bottom, and therefore the proportion of reflected light reaching the observer to transmitted light gradually increases from top to bottom. A visually pleasing effect can also be obtained when a single coloured, translucent sheet is placed on a translucent white sheet or vice versa.

Alternatively, the flexible support sheet may be translucent and coloured or white and the flexible support sheet retain a translucent sheet of different colours such that the backdrop support may form a colour gradient such that the colour of the backdrop appears to change from the top to the bottom, for example. In this case the stand is typically translucent and of the same hue as the flexible support sheets.

The flexible support sheet may retain two translucent flexible or white sheets (for example, two translucent flexible sheets of different colours or one translucent white and one translucent coloured sheet) and be spot lit from behind. That is the centre of the backdrop support may be lit more brightly than the edges of the backdrop support. Such a lighting arrangement may produce a haloing effect around an object to be photographed placed on the translucent flexible coloured or white sheet in addition to the colour gradient described above.

The backdrop support may be lit from below if placed upon a transparent surface, such as a glass top table, for example. A colour gradient or a haloing effect may be produced analogously to those produced when lit from behind as described above.

It can be advantageous for at least one sheet retaining formation to be configured to retain at least three sheets. Thus a translucent white sheet may be placed on the flexible support sheet and then a single coloured translucent sheet or a plurality of translucent sheets of different colours retained on top. The translucent white sheet can help to diffuse light from a light source.

According to a second aspect of the invention there is provided a method of using a backdrop support according to the first aspect of the invention, comprising the steps of;

deploying the backdrop support with the flexible support sheet attached to the stand and extending from the stand to form a curve;

attaching one or more sheets to the flexible support sheet such that the one or more sheets form a backdrop for a photograph;

placing an object on the one or more sheets retained by the at least one sheet retaining formation;

such that the one or more sheets form a smooth backdrop to the object suitable for photography.

Preferably, the method extends to taking a photograph of an object with the one or more sheets retained by the at least one sheet retaining formation forming the backdrop of the photograph.

According to a third aspect of the invention there is provided a kit comprising a stand and a flexible support sheet attachable to the stand configured to be assembled into the backdrop support according to the first aspect of the invention.

The flexible support sheet may be demountably attached to the stand.

Preferably, the kit further comprises one or more sheets which may be demountably retained on the flexible support sheet of the backdrop support.

Preferably, the one or more sheets are of different colours. The one or more sheets may be translucent. The one or more sheets may be opaque. The one or more sheets may comprise at least two sheets. The at least two sheets may comprise at least one translucent sheet and one opaque sheet. There may be at least three sheets. The kit may comprise a translucent white sheet, and at least three translucent sheet of different colours. The kit may also comprise an opaque white sheet.

The kit may take the form of a stack of sheets (comprising the said one or more sheets, the flexible support sheet, and the stand, in sheet form).

According to a fourth aspect of the invention there is provided a method of using a kit according to the third aspect of the invention, comprising the steps of;

assembling the kit into a backdrop support according to the first aspect of the invention, with one or more sheets retained on the flexible support sheet; and

placing an object on the one or more retained sheets such that the one or more sheets form a smooth backdrop to the object suitable for photography.

Preferably, two coloured translucent sheets of different colours, or a coloured translucent sheet and a white sheet are retained on the flexible support sheet and form a smooth backdrop to the object suitable for photography.

The backdrop support may be stood on one of the sheets, typically a translucent or opaque white sheet.

Preferably, the method extends to comprise the step of taking a photograph of an object with the one or more sheets retained by the flexible support sheet forming the backdrop of the photograph.

Complex effects may be produced by retaining multiple coloured sheets, such as a colour gradient effect.

Optional features of each of the first through fourth aspects of the invention are optional features of any of the first through fourth aspects of the invention.

### DESCRIPTION OF THE DRAWINGS

An example embodiment of the present invention will now be illustrated with reference to the following Figures in which:

FIG. 1 is a side view of a backdrop support retaining two coloured sheets according to the present invention;

FIG. 2 is a front view of a backdrop support according to the present invention;

FIG. 3 is a side view of a backdrop support according to the present invention;

FIG. 4 is a perspective view of a backdrop support retaining two coloured sheets according to the present invention;

FIG. 5 is a perspective view of the backdrop support in flat packed form;

FIG. 6 is a plan view of the backdrop support of FIG. 5 opened out;

FIG. 7 is a plan view of an alternative backdrop support in which the stand and flexible sheet are separate;

FIG. 8 is a perspective view of a backdrop support retaining two coloured sheets and illuminated from behind;

FIG. 9 is a perspective view of a backdrop support retaining two coloured sheets and illuminated from below;

FIG. 10 is a perspective view of a backdrop support retaining two coloured sheets and spot lit from behind; and

FIG. 11 is a perspective view of a backdrop support retaining two coloured sheets and spot lit from below.

### DETAILED DESCRIPTION OF AN EXAMPLE EMBODIMENT

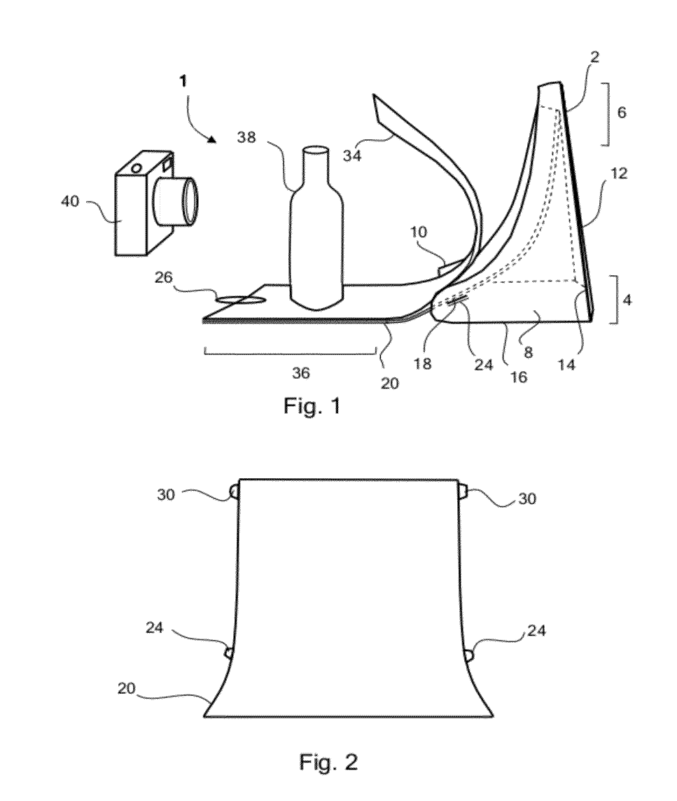

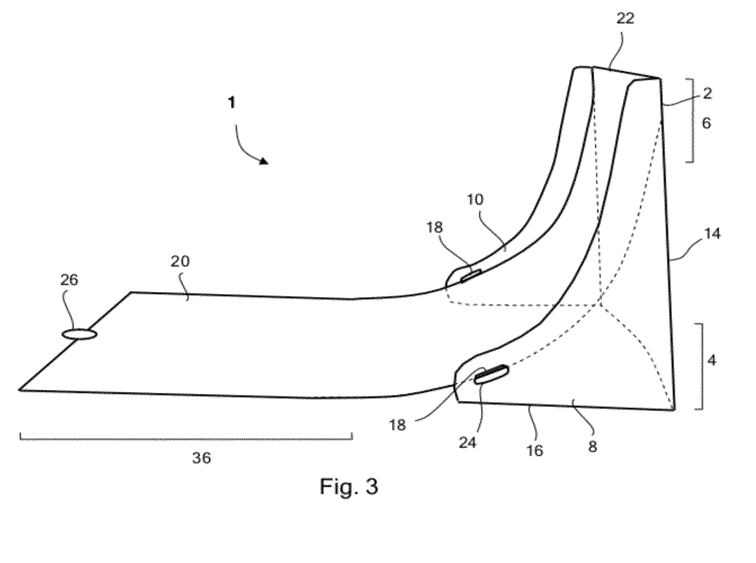

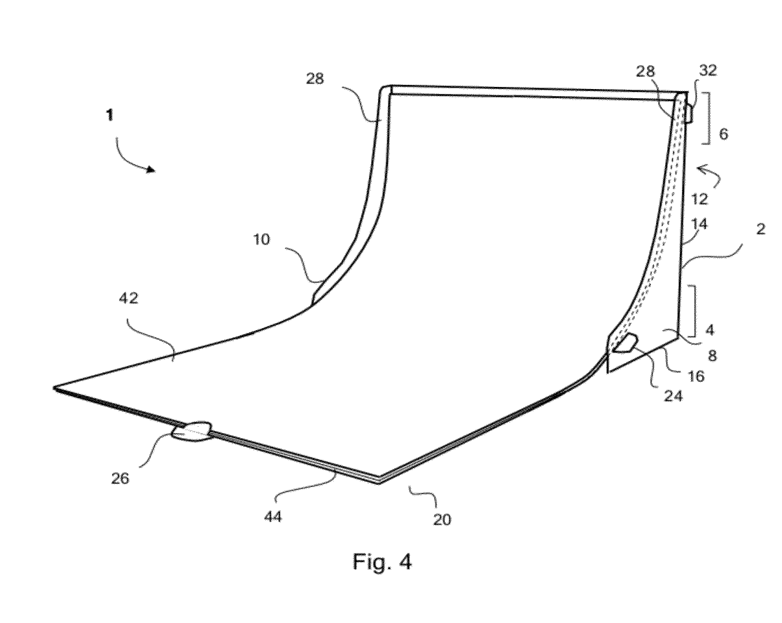

With reference to FIGS. 1 to 4, a backdrop support 1 comprises a stand 2 comprising a base 4 (acting as a base end) and an opposed support end 6, the base acting as a surface engaging formation. The stand comprises two bracket portions 8, 10 and a connecting back portion 12 between the two bracket portions. The two bracket portions are generally “L” shaped and a first exterior side 14 of the bracket portions abuts the connecting back portion such that, in use, the abutment rises perpendicularly from the surface the backdrop support is stood on. A second exterior side 16 of the bracket portions extends perpendicularly to the first exterior side of the bracket portions parallel to the surface the backdrop support is stood on in use.

Each of the bracket portions comprises an aperture 18 adjacent to the second exterior side, opposed to the abutment between the bracket portion and the back portion.

The backdrop support further comprises an oblong flexible sheet (acting as a flexible support sheet) 20 attached to the support end of the stand via a joint 22, which functions as a hinge connecting one of the shortest edges of the flexible sheet support and the support end of the stand. The flexible support sheet forms a curved surface extending away from the stand, with an incurvate upper surface and an excurvate lower surface, when the backdrop support is assembled. The stand and flexible sheet are formed from a single piece of flexible substantially transparent polypropylene of about 0.8 mm thickness.

The flexible sheet comprises two opposed support tabs 24, one on each of the longest sides of the flexible sheet. The two opposed support tabs are inserted into the two apertures of the bracket portions of the stand such that the flexible sheet is supported and the curve which the flexible sheet adopts is defined. The flexible sheet comprises a retainer tab 26 (acting as a sheet retaining formation) adjacent to the end of the oblong flexible sheet furthest from the support end of the stand when assembled. The retainer tab is located on the lower shortest edge of the flexible sheet.

In some embodiments, a retainer tab is provided at each of the top and bottom of the flexible support sheet. In alternative embodiments the bracket portions of the stand comprise retainer tabs. In still further embodiments the flexible sheet and the bracket portions of the stand comprise retainer tabs.

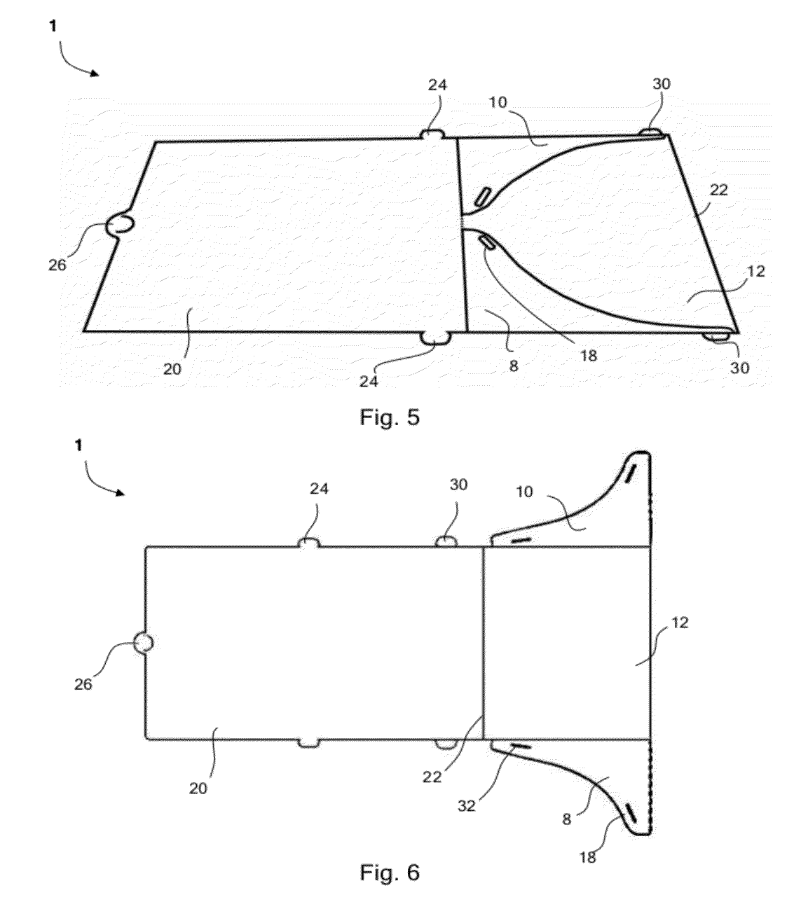

The backdrop support may be disassembled for storage or to be transported, by removing the opposed support tabs of the flexible sheet from the apertures in the bracket portions of the stand and the flexible sheet may be folded up to become planar and in the same plane as the back portion of the stand. The bracket portions of the stand may then be folded back such that the back portion of the stand, the bracket portions of the stand and the flexible sheet are all in a common plane. The now flat backdrop support may then be stored in a flat folder, such as that used to transport paper documents. The backdrop support is shown in its disassembled and flattened form in FIG. 5. FIG. 6 illustrates the same backdrop opened out further during assembly so the stand is adjacent rather than on top of the flexible sheet.

In an alternative embodiment of the invention, the flexible sheet further comprises two additional support tabs 30 (shown in FIGS. 2, 5 and 6) on opposed edges of the longest side of the flexible sheet adjacent to the support end of the stand when assembled and the bracket portions of the stand further comprises two additional apertures 32 adjacent to the support end of the stand, the aperture of one bracket portion opposed that of the second bracket portion when assembled. The flexible sheet is attached to the stand of the backdrop support by inserting the four support tabs into the respective apertures in the brackets of the stand.

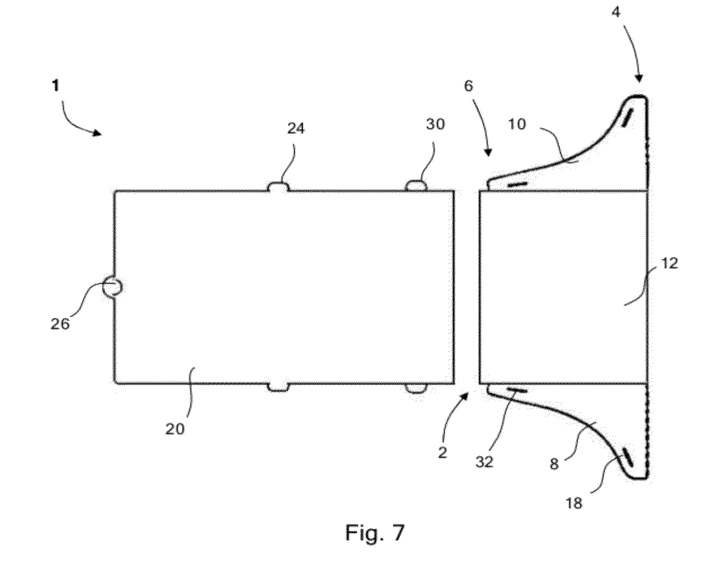

In some embodiments, the stand and the flexible sheet are formed from separate sheets which are demountably attachable to each other. An example of such an embodiment is shown in FIG. 7.

In use, the backdrop support is placed on a horizontal surface, such as a table, and a flexible coloured sheet 34 is inserted between the walls 28 defined by the brackets and held by the retainer tab on the flexible sheet of the backdrop support. The flexible coloured sheet lies on the upper incurvate surface of the flexible sheet, curving down from and extending away from the stand such that a planar portion 36 of the flexible coloured sheet forms a surface generally parallel to the table on which the backdrop support is standing.

An object to be photographed 38 is positioned on the planar portion of the flexible coloured sheet. The camera 40 is positioned such that the object to be photographed is between the stand of the backdrop support and the camera. Therefore, the flexible coloured sheet forms the backdrop for the photograph to be taken. The object to be photographed and the flexible coloured sheet may be lit by the same white light source.

The flexible coloured sheet is translucent and may be lit from behind (that is, the flexible coloured sheet is positioned between the light source and the object to be photographed).

Alternatively, the flexible coloured sheet is opaque, the flexible coloured sheet is lit from in front and/or above. For example, the flexible coloured sheet may be opaque white, or red.

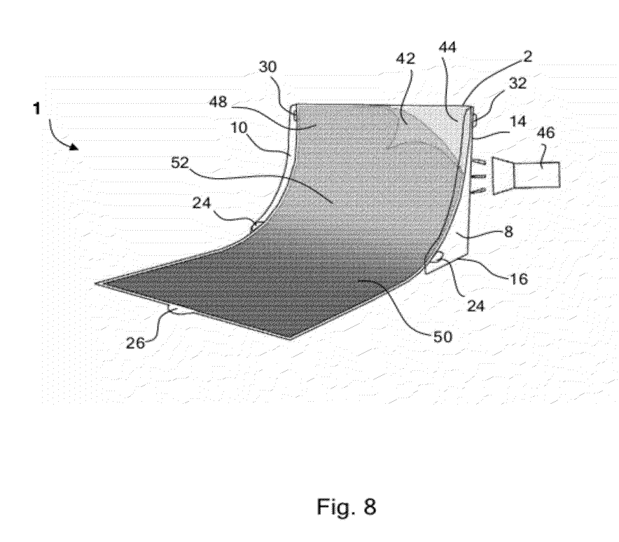

Alternatively, with reference to FIG. 8, two flexible translucent coloured sheets 42, 44 of different colours may be retained on the flexible sheet, one on top of the other. In this arrangement, especially when lit from behind by a light 46, the colour of light received by the camera is dependent upon where on the backdrop the light originates from. At the top of the backdrop 48, the surface is approximately normal to the viewer and therefore the majority of the light received is transmitted through the two sheets. Therefore the colour of the light received is a balanced mix of that of both sheets. At the bottom of the backdrop 50 the flexible coloured sheet has curved sufficiently that the light from behind the backdrop support passes through greater thicknesses of each sheet. Therefore, the colour of light received is predominantly the colour of the top sheet. This effect can also be compounded as reflected, rather than transmitted, light may form a higher proportion of light from the lower end of the backdrop support. Any such reflected light will be coloured more by the upper sheet. In between the top and bottom of the backdrop support 52, the surface is continuously curved and as for these reasons, a smooth colour gradient is produced.

For example, if a red and then a blue sheet were retained on the flexible sheet such that the blue sheet is at the surface, and the whole lit from behind the backdrop, the backdrop would appear to be purple at the top and to gradually change to blue towards the bottom of the backdrop.

Accordingly, a colour gradient effect may be easily created. Three or more translucent coloured sheets if different colours may be employed to form alternative gradients.

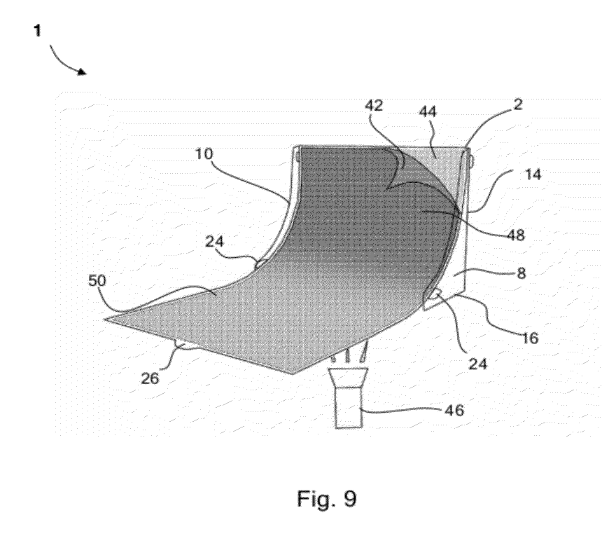

A similar effect can also be achieved with light from below (FIG. 9).

With reference to FIG. 7, the backdrop may be spot lit such that the centre of the backdrop 54 is brightly lit and the periphery if the backdrop 56 is dimly lit. Accordingly, a halo effect may be created around an object to be photographed.

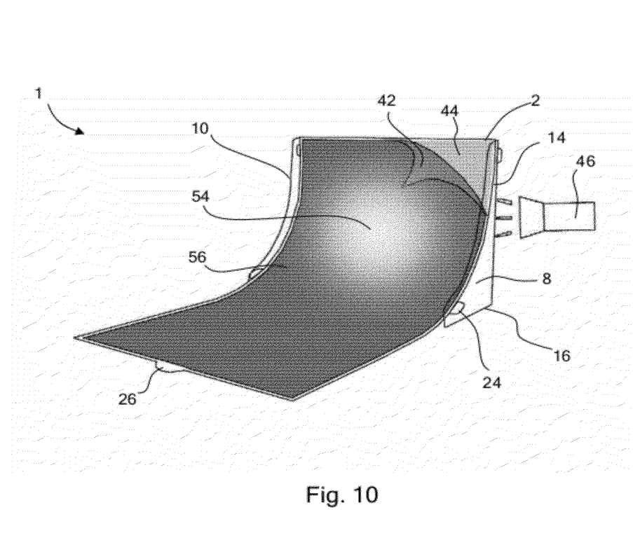

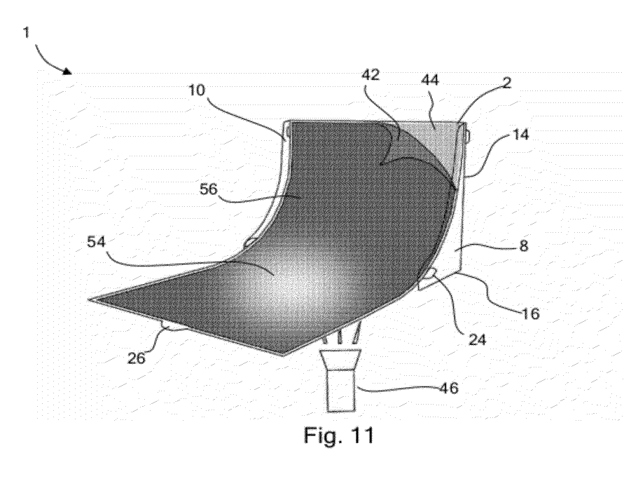

In alternate embodiments of the invention the backdrop support may be placed on a transparent surface, such as a glass topped table. In such embodiments where the flexible coloured sheet inserted between the first and second retainer tabs is translucent, the backdrop may be spot lit from behind (as shown in FIG. 10) or illuminated from below (as shown in FIG. 11).

In many applications, it is desirable for the stand to be rested on one of the sheets, typically on an opaque or translucent white sheet, to block out the colour of the underlying table and to ensure more even illumination of an object.

A translucent white sheet can also be used underneath a translucent coloured sheet, or two or more coloured sheets of different colours, to diffuse lights from a light source behind and/or below the backdrop support.

In further alternate embodiments of the invention the backdrop support may be placed on a transparent surface and two flexible, translucent coloured sheets retained on the flexible sheet. When lit from below and viewed from above, a colour gradient may be created analogously to previous embodiments.

In some applications, an object placed on the backdrop support will be lit from behind (through the backdrop support) and also from lights on either of the support balanced lighting, thereby providing an easy way of obtaining an image without shadows.

In an alternative embodiment, the flexible sheet is retained by retaining formations on the stand (for example, slits which demonstrably receive tabs extending from the flexible sheet). The retaining formation may, for example, be provided near the top of the stand and on the base of the stand. In this case, some or all of the retaining formations may also be used to retain one or more of the flexible, translucent coloured or white sheets on the flexible support sheet.

Further variations and modifications may be made within the scope of the invention herein disclosed.

1. A backdrop support comprising a stand and a flexible support sheet; the stand comprising a base end having a surface engaging formation for standing on a surface, and an opposed support end; the flexible support sheet being attached or attachable to at least the support end of the stand such that the flexible support sheet can extend from the stand and form a curved surface; wherein the backdrop support further comprises at least one sheet retaining formation configured to retain one or more sheets on the flexible support sheet.

2. A backdrop support according to claim 1, wherein the flexible support sheet is attached to at least the support end of the stand.

3. A backdrop support according to claim 2, wherein the backdrop support is substantially transparent.

4. A backdrop support according to claim 3, wherein the backdrop support is collapsible.

5. A backdrop support according to claim 4, wherein the flexible support sheet is demountably attached to the support end of the stand.

6. A backdrop support according to claim 4, wherein the flexible support sheet length is at least 1.5 times the distance from the base end to the support end of the stand.

7. A backdrop support according to claim 4, wherein the or each sheet retaining formation is configured to retain two or more sheets.

8. A backdrop support according to claim 4, retaining one or more coloured sheets on the flexible support sheet.

9. A backdrop support according to cliam 8, retaining one or more sheets on the flexible support sheet, at least one of which is translucent.

10. A backdrop support according to claim 9, retaining one or more sheets on the flexible support sheet, at least one of which is a translucent white sheet.

11. A backdrop support according to claim 10, retaining two or more sheets on the flexible support sheet, wherein two or more of the said sheets are translucent and are of different colours such that when illuminated a colour gradient is produced.

12. A method of using the backdrop support of claim 1, comprising the steps of;
deploying the backdrop support with the flexible support sheet attached to the stand and extending from the stand to form a curve;
attaching one or more sheets to the flexible support sheet such that the one or more sheets form a backdrop for a photograph;
placing an object on the one or more sheets retained by the at least one sheet retaining formation;
such that the one or more sheets form a smooth backdrop to the object suitable for photography.

13. A method according to claim 12 further comprising the step of taking a photograph of an object with the one or more sheets retained by the at least one sheet retaining formation forming the backdrop of the photograph.

14. A kit comprising a stand and a flexible support sheet attachable to the stand configured to be assembled into the backdrop support according to claim 1.

15. A kit according to claim 14, wherein the kit further comprises one or more sheets which is demountably retained on the flexible support sheet of the backdrop support.

16. A method of using a kit according to either one claim 14, comprising the steps of;
assembling the kit into a backdrop support with one or more sheets retained on the flexible support sheet; and
placing an object on the one or more retained sheets such that the one or more sheets form a smooth backdrop to the object suitable for photography.

17. A method of use according to claim 16 further comprising the step of taking a photograph of an object with the one or more sheets retained by the flexible support sheet forming the backdrop of the photograph.
